(19) United States
(12) Patent Application Publication
(10) Pub. No.: US 2003/0188017 A1
(43) Pub. Date: Oct. 2, 2003

(54) Internet connecting device automatic selection method, internet connecting device automatic selection system, and internet connecting device automatic selection program

(75) Inventor: Yoji Nomura, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/330,305

(22) Filed: Dec. 30, 2002

(30) Foreign Application Priority Data
Mar. 28, 2002 (JP) 2002-091740

(51) Int. Cl. G06F 15/173; G06F 15/16

(52) U.S. Cl. 709/241; 709/249

(57) ABSTRACT

A service provider fee information table is registered with a fee per content that is independently set by each ISP providing an Internet connection service, together with a URL of the content and an ID of the ISP. The ID of the ISP offering the minimum fee for each content among those registered in the service provider fee information table is registered in a first accounting mode selecting information table with the URL of the content. When each of the subscriber terminals connects to the Internet connecting device automation selection system to access any one the contents, the Internet connecting device of the ISP registered in the first accounting mode selecting information table with respect to the content is selected.

### BACKGROUND OF THE INVENTION

1. Field of the Invention

The present invention relates to an Internet connecting device automatic selection method of selecting one of a plurality of Internet connecting devices administered by different Internet service providers in order to connect a public network to the Internet when one of information terminals linked to the public network accesses a Web content on the Internet, an Internet connecting device automatic selection system for carrying out the Internet connecting device automatic selection method within the public network, and an Internet connecting device automatic selection program running on a computer linked to the public network so that the computer functions as the Internet connecting device automatic selection system.

2. Description of the Prior Art

An access to a Web site on the Internet from an information terminal linked to a public network administered by a common carrier (a network provider), has hitherto involved procedures, wherein a user connects his or her operating information terminal to an Internet connecting device administered by any one of Internet service providers (ISPs) with whom the user has previously established a contract of the service, then leases an IP address by sending to the Internet connecting device an ID and a password given from the ISP, and must thereafter transmit to the access destination Web site an HTTP (HyperText Transfer Protocol) request message packaged in an IP packet with the leased IP address and an IP address of the access destination Web site.

According to the contract which the user agrees with the ISP for receiving the Internet connection service described above, a fee for the service is determined in a flat-rate accounting system of charging a fixed amount of money per month as a service fee and in a quantity-based accounting system of charging an amount of money per actual connecting time.

By the way, in a cellular phone i-mode (trademark in Japan of NTT DoCoMo Inc.) service administered by NTT DoCoMo Inc. in Japan, if a user accesses a specified Web site on the Internet via an Internet connecting device (i-mode center) and downloads a fee-charged content opened on this specified Web site, the fee for utilizing the fee-charged content is collected as added to a fee for the Internet connection service from the user by the administrator of the Internet connecting device (i-mode center).

Thus, the accounting mode for the Internet connection service is diversified into multiple modes without being limited to the conventional flat-rate and quantity-based accounting systems, and those accounting modes launch into their implementations. Then, when those multiple accounting modes are carried out, the user can choose, each time the user accesses the Web site on the Internet, an ISP providing the most advantageous Internet connection service under connecting conditions (such as a connection time zone, a necessary communication speed, an access target content and so on) at that time, and can connect his or her operating terminal to the Internet connection device of this selected ISP.

For example, the user, who gives the top priority to how much low the fee can be restrained, fastidiously selects the ISP offering the minimum fee for every connection time zone and for every access target content, and can therefore restrain a sum of fees per month lower than an amount of money charged by the flat-rate accounting system in the case of fixing the ISP.

### SUMMARY OF THE INVENTION

It is a primary object of the present invention to provide, under such an Internet connection environment, an Internet connecting device automatic selection method of selecting an ISP providing at a minimum fee an Internet connection service for accessing an access target content among the previously registered ISPs each time a user operating an information terminal linked to a public network accesses a Web content on the Internet, and connecting this information terminal to an Internet connecting device administered by this selected ISP, an Internet connecting device automatic selection system for carrying out the Internet connecting device automatic selection method within the public network, and an Internet connecting device automatic selection program running on a computer linked to the public network so that the computer functions as the Internet connecting device automatic selection system.

According to the present invention devised to accomplish the above object, an Internet connecting device automatic selection method includes steps of referring to a table stored with information about the Internet connecting device offering a minimum connecting fee for each content when any one of the communication terminals requests to access a specified content on the Internet, to select the Internet connecting device registered with respect to the specified content in the table, and making the communication terminal access the specified content via the selected Internet connecting device.

With this scheme, in a case where the parties administering the respective Internet connecting devices offering connection fees to be charged for every access to the content, it is possible to automatically select the Internet connecting device administered by the party providing the Internet connection service at the minimum connection fee for every content.

In the Internet connecting device automatic selection method according to the present invention, the table may be structured of a first table stored with a connecting fee for each content that is independently offered by a party administering the each Internet connecting device with identifying information of the content and identifying information of the party, and a second table stored, for every content, with the identifying information of the party offering the minimum connecting fee among those registered in the first table together with the identifying information of this content.

Further, in the Internet connecting device automatic selection method according to the present invention, the first table may be stored further with a connecting fee per a unit of time independently offered by the party administering the each Internet connecting device, a third table may be registered with the identifying information of the party offering the minimum connecting fee per a unit of time among those registered in the first table, and a fourth table may be registered with information indicating which accounting mode an owner of the each communication terminal desires for, a mode of charging a fee each time a content is accessed, or a mode of charging a fee per a unit of accessing time. Then, when any one of the communication terminals requests to access a specified content on the Internet, the Internet connecting device administered by the party registered with respect to said special content in the second table may be selected if the fourth table is registered with that the owner of the communication terminal desires for the mode of charging a fee each time a content is accessed, whereas, the Internet connecting device administered by the party registered in the third table may be selected if the fourth table is registered with that the owner of the communication terminal desires for the mode of charging a fee per a unit of time.

With this scheme, if the parties administering the respective Internet connecting devices offers charging connection fee per a unit of time in addition to the charging connection fee for every access to a content, the user can select any one of the accounting systems.

In the Internet connecting device automatic selection method according to the present invention, the fourth table may be registered further with information indicating which selection the owner of the each communication device desires for, a selection prioritizing fee or a selection prioritizing communication speed, a fifth table may be registered with communication speed of the each Internet connecting device together with the identifying information of the party administering the Internet connecting device, and a sixth table may be registered with the identifying information of the party administering the Internet connecting device exhibiting the highest communication speed among those registered in the fifth table. Then, when any one of the communication terminals requests to access a specified content on the Internet, the Internet connecting device administered by the party registered in the second table or the third table may be selected if the fourth table is registered with that the owner of the communication terminal desires for the selection prioritizing fee, whereas the Internet connecting device administered by the party registered in the sixth table may be selected if the fourth table is registered with that the owner of the communication terminal desires for the selection prioritizing communication speed.

With this scheme, each user can arbitrarily select the Internet connecting device exhibiting a higher communication speed in preference to other circumstances in accordance with a user's own convenience, and can also select the Internet connecting device to which the minimum connection fee is set in preference to other circumstances.

### BRIEF DESCRIPTION OF THE DRAWINGS

The invention will be described below in detail with reference to the accompanying drawings, in which:

FIG. 1 is a block diagram showing a communication system in an embodiment of the present invention;

FIG. 2 is a table logically showing a data structure of a subscriber information table;

FIG. 3 is a table logically showing a data structure of a service provider information table;

FIG. 4 is a table logically showing a data structure of a service provider fee information table;

FIG. 5 is a table logically showing a data structure of a first accounting mode selecting information table;

FIG. 6 is a table logically showing a data structure of a second accounting mode selecting information table;

FIG. 7 is a table logically showing a data structure of a communication speed information table;

FIG. 8 is a flowchart showing a process based on a subscriber information input module;

FIG. 9 is a flowchart showing a process based on a service provider information input module;

FIG. 10 is a flowchart showing a process based on a communication speed confirmation module;

FIG. 11 is a flowchart showing a process based on a connection selection module;

FIG. 12 is a diagram showing a subscriber information input screen;

FIG. 13 is a diagram showing a service provider information input screen;

FIG. 14 is a diagram showing a connection fee per a unit of time change screen;

FIG. 15 is a diagram showing a registered URL information change screen;

FIG. 16 is a diagram showing a registered URL information adding screen; and

FIG. 17 is a conceptual diagram showing a flow of fees.

### DESCRIPTION OF THE PREFERRED EMBODIMENT

A preferred embodiment of the present invention will hereinafter be described with reference to the accompanying drawings.

According to an Internet connecting device automatic selection method of the present invention, a category of a public network to which information terminal are linked is not limited, and includes a fixed telephone network such as an analog line network and an ISDN (Integrated Services Digital Network), as well as a mobile phone network such as a car telephone network and a cellular phone network. In the following example, however, what is assumed as a public network is the cellular phone network categorized also as a packet network for switching digital data with a packet, and what is assumed as an information terminal linked to the cellular phone network is a digital cellular phone incorporating an Internet connecting function that supports PPP (Point-to-Point Protocol), IP (Internet Protocol) and PDC-P (Personal Digital Cellular Packet), TCP (Transfer Control Protocol) and TLP (Transfer Layer Protocol), HTTP (HeyperText Transfer Protocol) and ALP (Application Layer Protocol), HTML (HyperText Markup Language) or C-HTML.

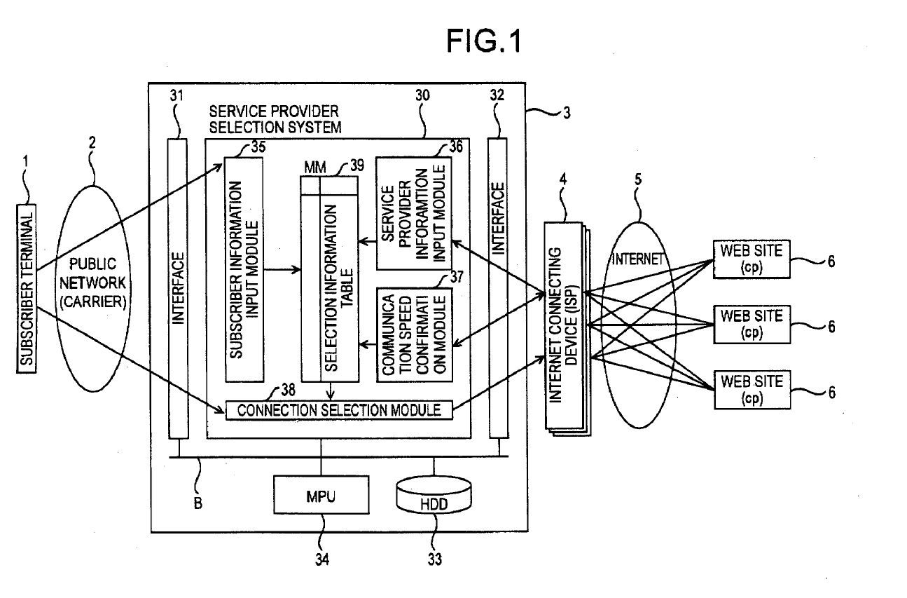

FIG. 1 is a block diagram showing an outline of architecture of a communication system for embodying the Internet connecting device automatic selection method. This system is configured by a public network 2 administered by a common carrier (which will hereinafter simply called a carrier), a plurality of subscriber terminals (only one of which is illustrated in FIG. 1) 1 serving as information terminals operated respectively by users (who will hereinafter be called “communication subscribers”) each establishing a telephone subscription contract with the carrier, one single service provider automatic selection system 3 administered by a selection system manager, a plurality of Internet connecting devices 4 each administered by a different ISP (Internet Service Provider), an Internet 5 and a plurality of Web sites 6 provided by content providers.

The subscriber terminal 1, though its detailed configuration is not shown in FIG. 1, is constructed of a memory stored with a communication program for actualizing the Internet connecting function described above and Web Browser, a CPU (Central Processing Unit) for executing these programs, an input device (a keyboard having ten keys, etc) for inputting commands and data to the CPU, and a display for displaying a variety of screens showing results of processing by the CPU.

The public network 2 is configured by ground stations installed in a way that covers all over the country in order to wirelessly communicate with the respective subscriber terminals 1, and a group of high-order switches connected via leased lines to these ground stations. An IP (Internet Protocol) packet forwarded to each subscriber terminal 1 from the Internet 5, is encapsulated into a PDC protocol packet and thus forwarded within the public network.

The Internet connecting device automatic selection system 3 is one category of switch system connected to the public network. This selection system 3 is constructed of a first interface 31 accommodating lines to be linked to the subscriber terminals 1, a second interface 32 accommodating lines to be linked to the respective Internet connecting devices 4, a main memory (corresponding to a storage device, a first storage module and a second storage module) 30 defined as an operation area for processing the data received via the interfaces 31 or 32, an MPU (Main Processing Unit corresponding to a selection module and a connection module) 34 for controlling respective pieces of hardware and processing the data on the main memory 30, and a hard disk 33 stored with the various programs and various items of data that are read onto the main memory 30 and executed by the MPU 34, wherein these components are connected to each other via a bus (containing a data bus and a control bus) B.

Each of the interfaces 31, 32 extracts data (control data or the IP packet) from the PDC packet received via the line and sends the extracted data to the main memory 30. Then, each of the interfaces 31, 32 decodes information about a destination and so on of the data and notifies the MPU 34 of the decoded information. Reversely, each of the interfaces 31, 32 encapsulates the data processed on the main memory 30 into a PDC packet and forwards the PDC packet to a destination set in the header of this packet within the public network 2.

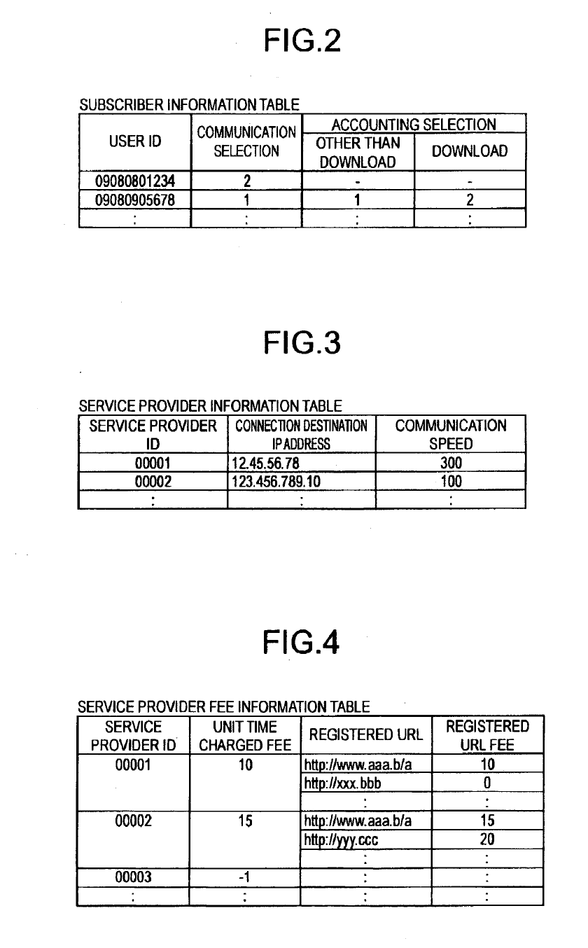

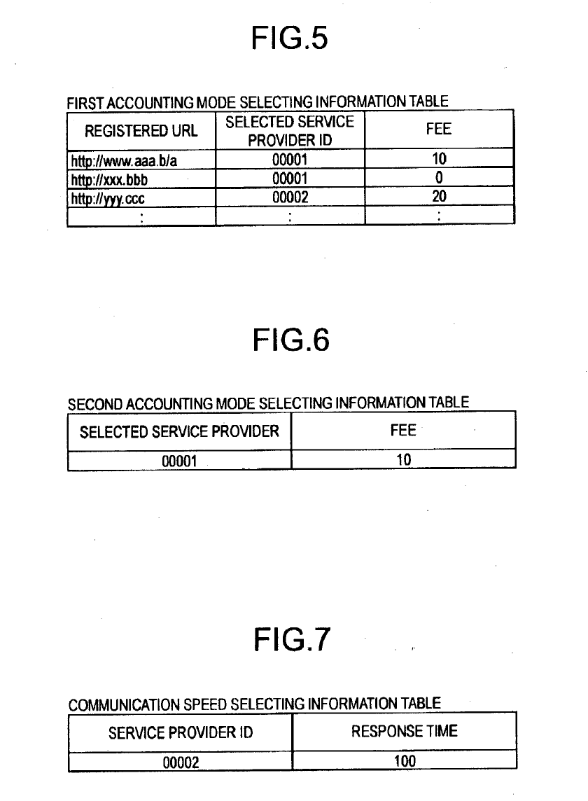

Data stored on the hard disk 33, read onto the main memory 30, referred to and updated by the MPU 34 and thereafter returned to the hard disk 33, contain a table suite that structures a selection information table 39. This table suite contains a subscriber information table (a fourth table) shown in FIG. 2, a service provider information table (a fifth table) shown in FIG. 3, a service provider fee information table (a first table corresponding to a first storage module) shown in FIG. 4, a first accounting mode selecting information table (a second table corresponding to a second storage module) shown in FIG. 5, a second accounting mode selecting information table (a third table) shown in FIG. 6, and a communication speed selecting information table (a sixth table) shown in FIG. 7.

FIG. 2 shows a table logically illustrating a data structure of the subscriber table information. As shown in FIG. 2, this subscriber information table is stored with records each consisting of pieces of data entered in a “user ID” field, a “communication selection” field and an “accounting mode selection” field for every communication subscriber. The “user ID” field is registered with a piece of identifying information such as a telephone number of the communication subscriber, by which the communication subscriber can be uniquely identified. A value (1: accounting) indicating that the communication subscriber desires to select ISP (the Internet connecting device 4) with prioritizing fee or a value (2: communication speed) indicating that the communication subscriber desires to select a ISP with prioritizing communication speed, is set in the “communication selection” field. In other words, the “communication selection” field is registered with the data indicating the fee-based selection or the communication-speed-based selection desired by the subscriber. The “accounting mode selection” field is a field that becomes valid only when “1: accounting” is set in the “communication selection” field corresponding thereto. This “accounting mode selection” field is subdivided into a “download” subfield and an “other than download” subfield. With respect to each session of the data communication, a value (1: content-by-content accounting) indicating that the communication subscriber desires to be charged a fee for every content or a value (2: time-rate accounting) indicating that the subscriber desires to be charged a fee per a unit of time, is set in the above subfield. In other words, each subfield is registered with the data indicating the subscriber desires to be charged a fee each time the user accesses the content or the data indicating that the subscriber desires to be charged a fee per a unit of time. Note that information about each individual communication subscriber is registered in this subscriber table on the basis of an application made beforehand by the same communication subscriber to the selection system manager.

FIG. 3 is a table logically showing a data structure of the service provider information table. As shown in FIG. 3, the service provider information table is stored with records each consisting of pieces of data entered in a “service provider ID” field, a “connection destination IP address” field and a “communication speed” field for every ISP. The “service provider ID” field is registered with a piece of identifying information for uniquely identifying the ISP. The “connection destination IP address” field is registered with an IP address, based on which the Internet connecting device 4 administered by the ISP is accessed. The “communication speed” field is registered with a response time (of which unit is “ms”) when the communication subscriber accesses the Web site 6 on the Internet 5 via the Internet connecting device 4 administered by the ISP.

FIG. 4 is a table logically showing a data structure of the service provider fee information table. As illustrated in FIG. 4, the service provider fee information table is stored with records each consisting of pieces of data entered in a “service provider ID” field, a “unit time charged feel” field, a “registered URL” field and a “registered URL fee” field showing a mapping of each fee value to each URL for every ISP. The “service provider ID” field is registered with the same identifying information as registered in the “service provider ID” field in the service provider information table (FIG. 3). The “unit time charged fee” field is registered with a connection fee (of which unit is “yen”) per a unit of time (one minute), which is applied in the case where the ISP charges a fee per a unit of time in time-rate accounting system. If the ISP does not adopt the time-rate accounting, however, “−1” is set in the “unit time charged fee” field. Each line of the “registered URL” field is registered with a URL (Uniform Resource Locator) (which is defined as the content identifying information) of the content on the Web site 6 accessible via the Internet connecting device 4 administered by the ISP. Each line of the “registered URL fee” field is registered with an access fee (of which unit is “yen”), i.e., a connection fee per content, for accessing the URL registered in the corresponding “registered URL” field, which is applied in the case where the ISP charges a fee for every content in content-by-content accounting system.

FIG. 5 is a table logically showing a data structure of the first accounting mode selecting information table. As shown in FIG. 5, the first accounting mode selecting information table is stored with records each consisting of pieces of data entered in a “registered URL” field, a “selected service provider ID” field and a “fee” field for every Web site (content) accessible by each subscriber terminal through this communication system. The “registered URL” field is registered with the URL of the connection destination of the content. The “selected service provider ID” field is registered with a piece of identifying information of the ISP corresponding to the value entered in the “service provider ID” field in the service provider fee information table (FIG. 4), who offers the minimum connection fee for the content having the URL registered in the corresponding “registered URL” field. The “feel” field is registered with the minimum connection fee for the content , which corresponds to the value entered in the “registered URL fee” field in the service provider fee information table (FIG. 4).

FIG. 6 is a table logically showing a data structure of the second accounting mode selecting information table. As shown in FIG. 6, the second accounting mode selecting information table is stored with only one record consisting of pieces of data entered in a “selected service provider ID” field and a “fee” field. The “selected service provider ID” field is registered with the identifying information of the ISP corresponds to the value in the “service provider ID” field in the service provider fee information table (FIG. 4), who offers the minimum connection fee per a unit of time. The “fee” field is registered with the minimum connection fee per a unit of time, which corresponds to the value in the “unit time charged fee” field in the service provider fee information table (FIG. 4).

FIG. 7 is a table logically showing a data structure of the communication speed selecting information table. As shown in FIG. 7, the communication speed selecting information table is stored with only one record consisting of pieces of data entered in a “service provider ID” field and a “response time” field. The “service provider ID” field is registered with the identifying information of the ISP corresponding to the value in the “service provider ID” field in the service provider information table (FIG. 3), for whom is registered the shortest response time corresponding to the value in the “communication speed” field in the service provider information table (FIG. 3).

Further, the various categories of programs (corresponding to an Internet connection device automatic selection program) read onto the main memory 30 and executed by the MPU 34, contain a plurality of program modules (a subscriber information input module 35, a service provider information input module 36, a communication speed confirmation module 37 and a connection selection module 38).

The subscriber information input module 35 is defined as a program module for updating the record of the communication subscriber registered in the subscriber information table (FIG. 2) on the basis of the control information transmitted to the MPU 34 by each individual communication subscriber operating the subscriber terminal 1.

The service provider information input module 36 is defined as a program module for registering the ISP record in the service provider fee information table (FIG. 4) on the basis of the control information transmitted to the MPU 34 by each ISP operating an unillustrated console of the Internet connecting device 4.

The communication speed confirmation module 37 is defined as a program module for measuring a response speed from the Web site 6 in a way that accesses the Web site 6 on the Internet 5 via the Internet connecting device 4 administered by each ISP, and registering the measured response time in the “communication speed” field in the service provider information table (FIG. 3).

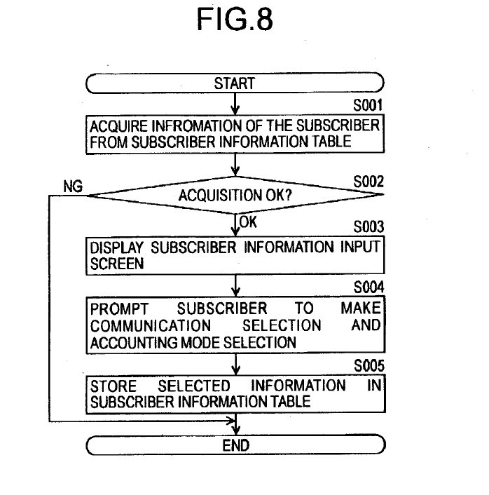

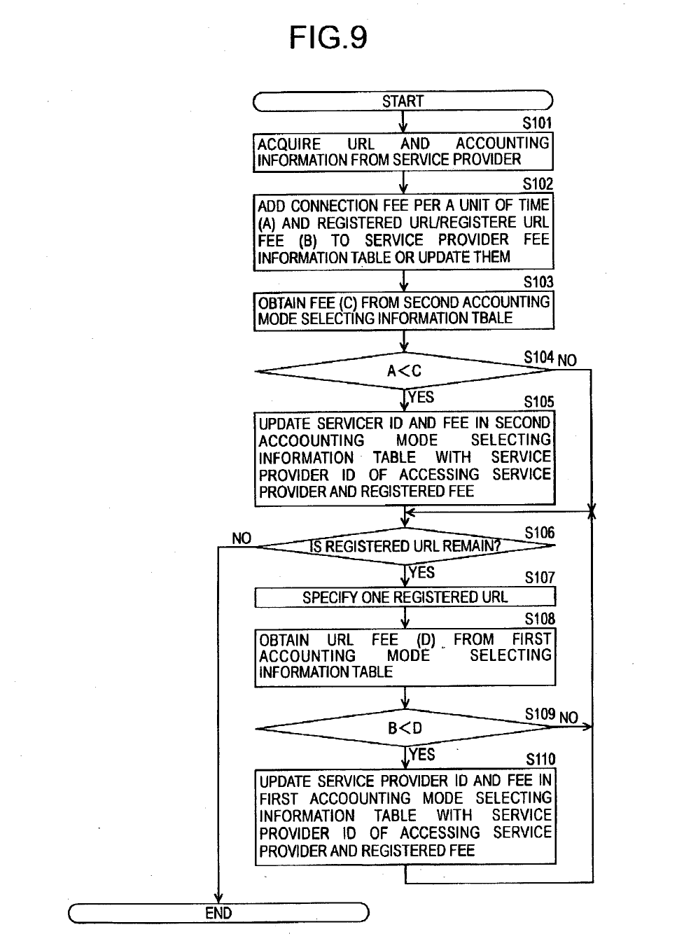

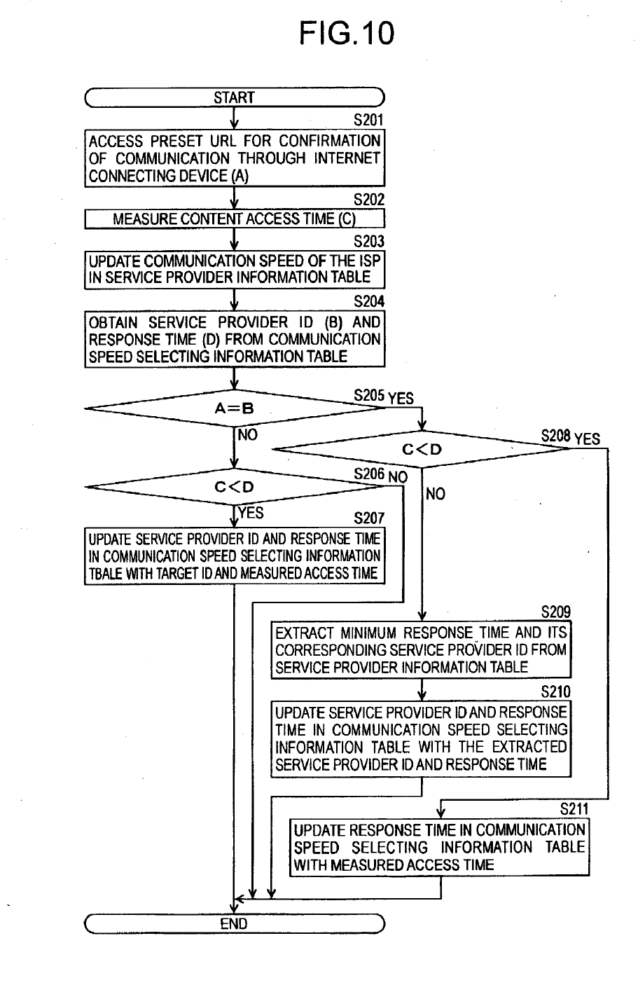

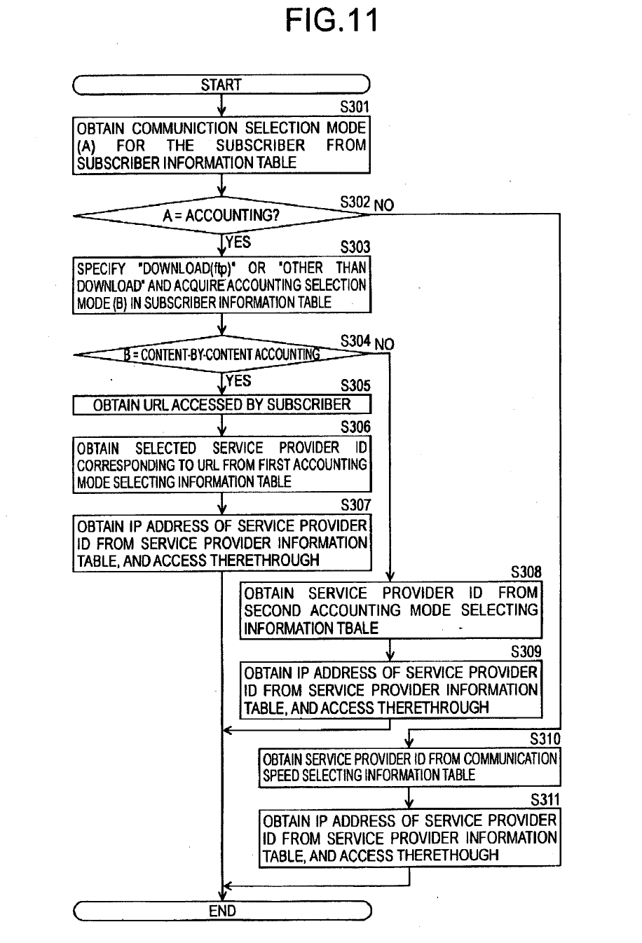

Respective processes executed by the MPU 34 in accordance with the above program modules stored in the hard disk 33, will hereinafter be explained with reference to flowcharts in FIGS. 8 through 11.

The discussion starts with explaining the process based on the subscriber information input module 35. A start of this process is triggered by detecting that the packet transmitted to the service provider automatic selection system 3 from any one of the subscriber terminals 1 is a packet containing a request message specifying a predetermined URL.

Then, in first step S001 after the start, the MPU 34 executes a process of reading from the subscriber information table (FIG. 2) a record about the communication subscriber possessing the subscriber terminal 1 which sent the packet.

In next step S002, the MPU 34 checks whether the record has been read as a result of the process in S001. Then, if the read of the same record is unsuccessful, the MPU 34 judges that the information on this communication subscriber is not yet registered in the subscriber information table (FIG. 2), i.e., that the communication subscriber does not yet apply to the selection system manager for a registration thereof, and directly terminates all the processes.

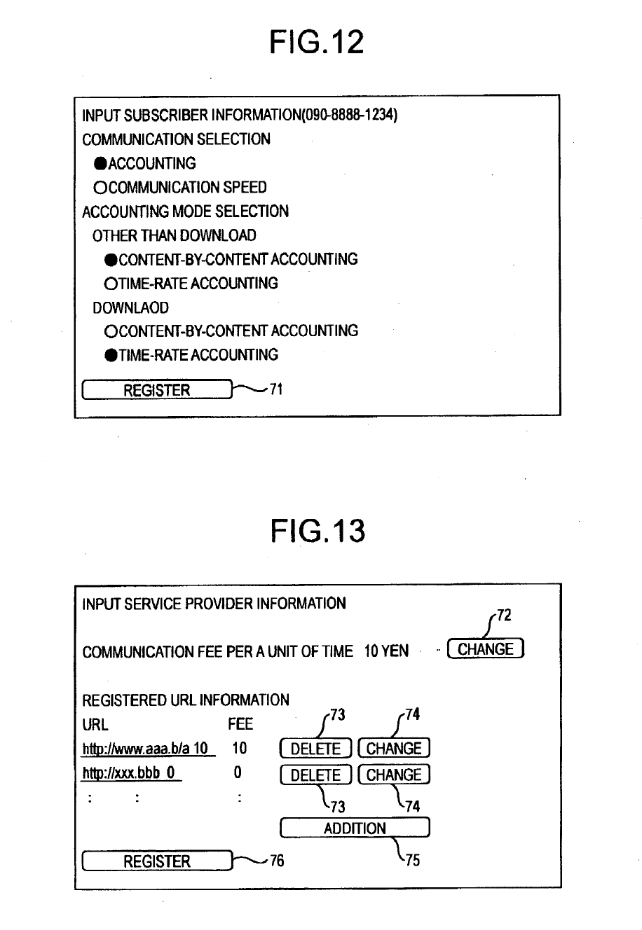

On the other hand, when judging in S002 that the record has been read, the MPU 34 transmits screen data (HTML data) for displaying a subscriber information input screen shown in FIG. 12 to the subscriber terminal 1 which sent the packet in S003. As illustrated in FIG. 12, this subscriber information input screen contains an option button for selecting one of “1: accounting” and “2: communication speed” as values that should be registered in the “communication selection” field, an option button for selecting one of “1: content-by-content accounting” and “2: time-rate accounting” as values that should be registered in the “other than download” subfield of the “accounting mode selection” field when “1: accounting” is selected, an option button for selecting one of “1: content-by-content accounting” and “2: time-rate accounting” as values that should be registered in the “download” subfield of the “accounting mode selection” field, and a “register” button 71, whereby the communication subscriber operating the subscriber terminal 1 on which the subscriber information input screen is displayed, can make arbitrary settings. Then, an initial value of selection status of each option button is set based on the information presently registered in the “communication selection” field and “accounting mode selection” field of the record which is read from the subscriber information table (FIG. 2). Further, what is set to the “register” button 71 is action for making the Browser program running on the subscriber terminal 1 send to the service provider automatic selection system 3 a message for specifying selections statuses of all the option buttons when this “register” button 71 is manipulated by a “selection” key on the input device being pressed in a state where a cursor is placed on this “register” button 71.

In next step S004, the MPU 34 waits for messages as a result of such en event that the communication subscriber has made the selections with respect to the “communication selection” field and the “accounting mode selection” field on the subscriber information input screen of the subscriber terminal 1, and receives this message.

In next step S005, the MPU 34 analyzes the messages received in S004, and updates the same records as read in S001 from the subscriber information table (FIG. 2) on the basis of contents of selections with respect to the “communication selection” field and the “accounting mode selection” made by the communication subscriber. After a completion of processing in S005, the MPU 34 terminates all the processes based on the subscriber information input module 35.

Next, a process based on the service provider information input module 33 will be explained. A start of this process is triggered by detecting that the packet transmitted to the service provider automatic selection system 3 from any one of the Internet connecting devices 4 is a packet containing a request message specifying the predetermined URL.

Then, in first step S101 after the start, the MPU 34 reads from the service provider fee information table (FIG. 4) a record containing the “service provider ID” field registered with the identifying information of the ISP administering the Internet connecting device 4 which sent the packet, and generates screen data (HTML data) for displaying on the display of an unillustrated console a service provider information input screen in which the information contained in the readout record is reflected. Then, the MPU 34 transmits the thus generated screen data to the Internet connecting device 4 which sent the packet. As shown in FIG. 13, on this service provider information input screen are shown a value (connection fee per a unit of time) in the “unit time charged fee” field, and values (connection fee per content) in the “registered URL fee (fee)” fields respectively associated with their corresponding URLs of the “registered URL (URL)” fields, which are contained in the record read out of the service provider fee table (FIG. 4). Further, the service provider information input screen contains a “change” button 72 corresponding to the value in the “unit time charged feel” field, plural sets of a “delete” button 73 and a “change” button 74 respectively associated with their corresponding URLs of the “registered URL (URL)” fields, a “new addition” button 75 and a “register” button 76.

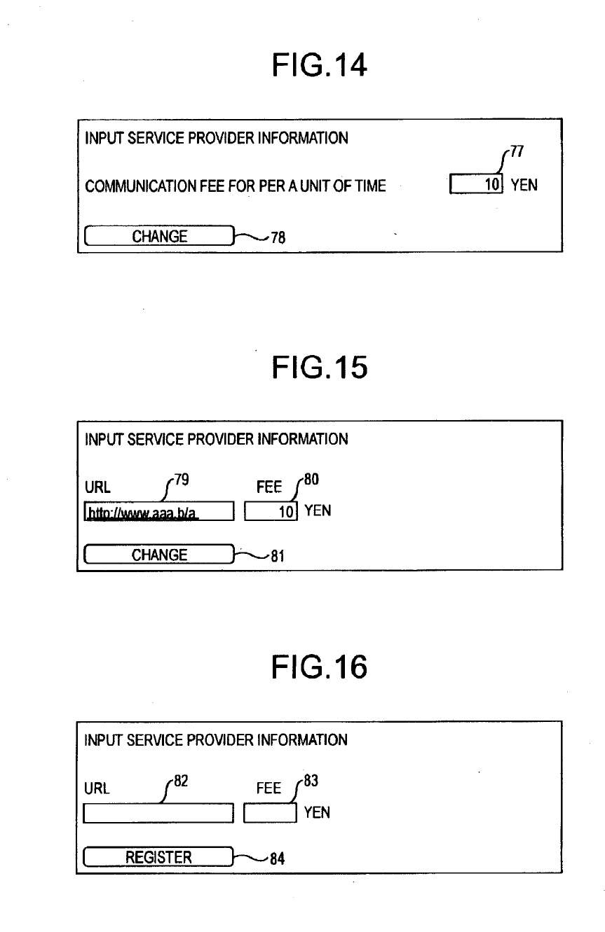

When the “change” button 72 is operated, the connection fee per a unit of time change screen shown in FIG. 14 is displayed on the display of the unillustrated console of the Internet connecting device 4. Because, a link to this connection fee per a unit of time change screen is set to the “change” button 72. This connection fee per a unit of time change screen contains a text box 77 for setting a connection fee per a unit of time after being changed, and a “change” button 78. When the “change” button 78 is operated in a state where the connection fee per a unit of time after being changed is set in this text box 77, the service provider input screen shown in FIG. 13 is updated by the changed connection fee per a unit of time set in the text box 77.

Further, to each “delete” button 73 is set an action for deleting the “registered URL (URL)” and a connection fee for content associated with the “delete” button 73.

Moreover, when any one of the “change” button 74 is operated, a registered URL information change screen shown in FIG. 15 is displayed on the display of the unillustrated console of the Internet connecting device 4. Because, a link to this registered URL information change screen is set to the “change” button 74. This registered URL information change screen contains a text box 79 for setting a registered URL after being changed, a text box 80 for setting the connection fee per content after being changed, and a “change” button 81. When the “change” button 81 is operated in a state where a registered URL and a connection fee per content are set respectively in the text boxes 79 and 80, the service provider information input screen shown in FIG. 13 is updated by the registered URL set in the text box 79 or/and by the connection fee per content set in the text box 80.

Further, when the “new addition” button 75 is operated, a registered URL information addition screen shown in FIG. 16 is displayed on the display of the unillustrated console of the Internet connecting device 4. Because, a link to this registered URL information addition screen is set to the “new addition” button 75. This registered URL information addition screen contains a text box 82 for setting a new registered URL, a text box 83 for setting a new connection fee per content and a “register” button 84. When the “register” button 84 is operated in a state where a new registered URL and a new registered connection fee per content are set respectively in the text boxes 83 and 84, the new registered URL set in the text box 82 and the new registered connection fee per content set in the text box 83, are associated with each other and then added to the service provider information input screen shown in FIG. 13. Further a “delete” button 3 and a “change” button 74 corresponding thereto are also added to the screen.

Moreover, what is set to the “register” button 76 is action for sending to the service provider automatic selection system 3 a message specifying the connection fee per a unit of time and each set of a registered URL and a connection fee per content which are displayed on the service provider information input screen (FIG. 13) at a point of time when the “register” button 76 is pressed. Upon receiving this message, the MPU 34 acquires the connection fee per a unit of time and the sets of the registered URL and the connection fee per content in addition to the previously obtained ISP identifying information (service provider ID).

In next step S102, the MPU 34 checks whether the ISP identifying information (service provider ID) obtained in S101 is registered in the service provider fee information table (FIG. 4). If already registered therein, the MPU 34 overwrites the connection fee per a unit of time and the sets of the registered URL and the connection fee per content which are obtained in S101, to the record containing the above ISP identifying information (service provider ID). Whereas if not yet registered, the MPU 34 adds, to the service provider fee information table (FIG. 4), a new record consisting of the ISP identifying information (service provider ID), the connection fee per a unit of time and the sets of the registered URL and the connection fee per content which are acquired in S101.

In next step S103, the MPU 34 reads a now-set value in the “fee” field from the second accounting mode selecting information table (FIG. 6).

In next step S104, the MPU 34 checks whether the connection fee per a unit of time added or overwritten to the “unit time charged fee” field in the service provider fee information table (FIG. 4) in S102 is smaller than the value read from the “fee” field of the second accounting mode selecting information table (FIG. 6) in S103. Then, if the connection fee per a unit of time in the “unit time charged fee” field is equal to or larger than the value in the “fee” field, the MPU 34 advances the processing directly to S106.

Whereas if the connection fee per a unit of time in the “unit time charged fee” field is smaller than the value in the “fee” field, the MPU 34 overwrites in S105 the ISP identifying information (service provider ID) and the connection fee per a unit of time obtained in S101 to the “selected service provided ID” field and the “fee” field in the second accounting mode selecting information table (FIG. 6). Upon a completion of the processing in S105, the MPU 34 proceeds the processing to S106.

A loop of the processes in S106 through S110 are processes for updating the first accounting mode selecting information table (FIG. 5) for every piece of ISP identifying information (service provider ID) acquired in S101. In first step S106 after entering this looped processing, the MPU 34 checks whether an unprocessed URL (registered URL) remains. Then, if one or more URLs (registered URLs) are obtained in S101, and if there remains any of the URLs (registered URLs) that do not yet undergo the processes from S107 onward, the MPU 34 advances the processing to S107.

In S107, the MPU 34 specifies one of the unprocessed URLs (registered URLs) as a processing target registered URL.

In next step S108, the MPU 34 reads, from the first accounting mode selecting information table (FIG. 5), a value (connection fee per content) in the “fee” field that is set at the present with respect to the processing target registered URL.

In next step S109, the MPU 34 checks whether the value (connection fee per content) in the “registered URL fee” field on same record as the processing target registered URL in the service provider fee information table (FIG. 4) in S102, is smaller than a value read from the “fee” field of the first accounting mode selecting information table (FIG. 5) in S108. Then, if the value (connection fee per content) in the “registered URL fee” field is equal to or larger than the value in the “fee” field, the MPU 34 loops the processing back to S106.

By contrast, when judging in S109 that the value (connection fee per content) in the “registered URL fee” field is smaller than the value in the “fee” field, the MPU 34 overwrites in S110 the ISP identifying information (service provider ID), the processing target registered URL obtained in S101 and the value (connection fee per content) in the “registered URL fee” field respectively to the “selected service provider ID” field, the “registered URL” field and the “fee” field in the first accounting mode selecting information table (FIG. 5). Upon a completion of processing in S110, the MPU 34 loops the processing back to S106.

In the case of judging in S106 that there is no unprocessed URL (registered URL) as a result of repeatedly executing the loop of the processes in S106 through S110 described above, the MPU 34 exits this loop of processing and terminates all the processes based on the service provider information input module 33.

Next, a process based on the communication speed confirmation module 37 will be explained. This process is periodically executed with respect to all the Internet connecting devices 4 registered in the service provider information table (FIG. 3). Accordingly, this process is executed by the MPU 34 in a state where the processing target ISP is specified.

In first step S201 after the start, the MPU 34 accesses a specified URL that is a preset URL for confirmation of communication on the Internet 5 via the Internet connecting device 4 administered by the processing target ISP, and makes a request for a content corresponding to this URL.

In next step S202, the MPU 34 measures a time elapsed till the content responded as a result of the request in S201 is received, and caches the measured time as a content access time.

In next S203, the MPU 34 updates the value in the “communication speed” field with respect to the processing target ISP registered in the service provider table (FIG. 3), with the content access time cached in S202.

In next step S204, the MPU 34 reads the values in the “service provider ID” and “response time” fields from the communication speed selecting information table (FIG. 7).

In next step S205, the MPU 34 checks whether the value read from the “service provider ID” field of the communication speed selecting information table (FIG. 7) in S204, is coincident with the identifying information of the processing target ISP. Then, if the value in the “service provider ID” field is coincident with the identifying information of the processing target ISP, the MPU 34 diverts the processing to S208. Whereas if the value in the “service provider ID” field is not coincident with the identifying information of the processing target ISP, the MPU 34 advances the processing to S206.

In S206, the MPU 34 checks whether the content access time cached in S202 is smaller than the value read from the “response time” field of the communication speed selecting information table (FIG. 7) in S204. Then, if the content access time is equal to or larger than the value in the “response time” field, the MPU 34 terminates all the processes based on the service provider information input module 33.

Whereas if the content access time is smaller than the value in the “response time” field, the MPU 34 updates in S207 the values registered in the “service provider ID” and “response time” fields of the communication speed selecting information table (FIG. 7) with the processing target ISP identifying information and the content access time cached in S202. Upon a completion of the process in S207, the MPU 34 terminates all the processes based on the service provider information input module 33.

On the other hand, in S208 executed when the value read from the “service provider ID” field of the communication speed selecting information table (FIG. 7) in S204 is coincident with the processing target ISP identifying information, the MPU 34 checks whether the content access time cached in S202 is smaller than the value read from the “response time” field of the communication speed selecting information table (FIG. 7) in S204. Then, if the content access time is equal to or larger than the value in the “response time” field, the MPU 34 extracts in S209 the minimum value in the “communication speed” field and the value of its corresponding “service provider ID” field from the service provider information table (FIG. 3). In next step S210, the MPU 34 updates the values registered in the “service provider ID” and “response time” fields of the communication speed selecting information table (FIG. 7), with the values in the “service provider ID” and “communication speed” fields which are extracted from the service provider information table (FIG. 3) in S209. Upon a completion of the process in S210, the MPU 34 terminates all the processes based on the service provider information input module 33.

By contrast, the MPU 34, when judging in S208 that the content access time is smaller than the value in the “response time” field, updates in S211 the value registered in the “response time” field of the communication speed selecting information table (FIG. 7) with the content access time cached in S202. Upon a completion of the process in S211, the MPU 34 terminates all the processes based on the service provider information input module 33.

Next, a process based on the connection selection module 38 will be described. A start of this process is triggered by detecting that the packet forwarded to the service provider automatic selection system 3 from any one of the subscriber terminals 1 is a packet containing a request message specifying a URL of a content on one of the Web sites 6.

Then, in first step S301 after the start, the MPU 34 reads the value registered in the “communication selection” field of the subscriber information table (FIG. 2) with respect to the communication subscriber defined as an owner of the subscriber terminal 1 which sent the message.

In next step S302, the MPU 34 checks whether the value read from the “communication selection”, field of the subscriber information table (FIG. 2) in S301 indicates “1: accounting” or “2: communication speed”. If the value in the “communication selection” field indicates “1: accounting”, the MPU 34 advances the processing to S303. If the value in the “communication selection” field indicates “2: communication speed”, the MPU 34 diverts the processing to S310.

In S303, the MPU 34 analyzes the request message received from the subscriber terminal, thereby specifying whether a requested communication mode is “download” in accordance with FTP (File Transfer Protocol) or not. Then, the MPU 34 reads, from the subscriber information table (FIG. 2), the value corresponding to the specified communication mode in the “accounting mode selection” field that is registered with respect to the communication subscriber as the owner of the subscriber terminal 1 which sent the message.

In next step S304, the MPU 34 checks whether the value in the “accounting mode selection” field that is read in S303 indicates “1: content-by-content accounting” or “2: time-rate accounting”. If the value in the “accounting mode selection” field indicates “1: content-by-content accounting”, the MPU 34 advances the processing to S305. If the value in the “accounting mode selection” field indicates “2: time-rate accounting”, the MPU 34 diverts the processing to S305.

In S305, the MPU 34 extracts a URL specified in the request message.

In next step S306, the MPU 34 reads a value of the “selected service provider ID” field corresponding to the URL extracted in S305, from the first accounting mode selecting information table (FIG. 5).

In next step S307, the MPU 34 reads a value (IP address) of the “connection destination IP address” field corresponding to the value in the “selected service provider ID” field that is read in S306, from the service provider information table (FIG. 3). Then, the MPU 34 attaches a packet header containing the readout IP address to the request message received from the subscriber terminal 1. Further, the MPU 34 sends through the interface 32 this request message toward the Internet connecting device 4 specified by the IP address. Upon a completion of the process in S307, the MPU 34 terminates the processes for this packet.

On the other hand, in S308, the MPU 34 reads the value registered in the “selected service provider ID” field of the second accounting mode selecting information table (FIG. 6).

In next step S309, the MPU 34 reads a value of the “connection destination IP address” field corresponding to the value in the “selected service provider ID” field that is read in S308, from the service provider information table (FIG. 3). Then, a packet header containing the readout IP address is attached to the request message received from the subscriber terminal 1. Further, the MPU 34 sends through the interface 32 this request message toward the Internet connecting device 4 specified by the IP address. Upon a completion of the process in S309, the MPU 34 terminates the processes for this packet.

On the other hand, in S310 executed when the value in the “communication selection” field indicates “2: communication speed”, the MPU 34 reads a value registered in the “service provider ID” of the communication speed selecting information table (FIG. 7).

In next step S311, the MPU 34 reads a value of the “connection destination IP address” field corresponding to the value in the “service provider ID” that is read in S310, from the service provider information table (FIG. 3). Then, the MPU 34 attaches a packet header containing the readout IP address to the request message received from the subscriber terminal 1. Further, the MPU 34 sends through the interface 32 this request message toward the Internet connecting device 4 specified by the IP address. Upon a completion of the process in S311, the MPU 34 terminates the processes for this packet.

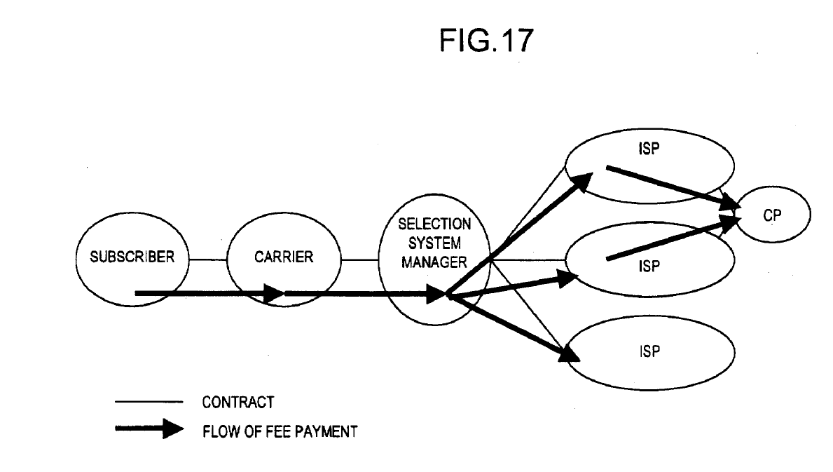

Note that the connection selection module 38, though not illustrated, further indicates the MPU 34 to charge to the communication subscriber a fee registered in the service provider fee information table (FIG. 4) by the ISP administering the Internet connecting device 4 through which a content specified by a URL is accessed, as an access according to the accounting mode determined by the value in the “communication selection” field and the value in the “accounting mode selection” field (wherein if the value in the “communication selection” field indicates “2: communication speed”, the time-rate accounting mode is always adopted) registered in the subscriber information table (FIG. 2) with respect to the communication subscriber possessing the subscriber terminal 1, whenever the subscriber terminal 1 accesses to the content. More specifically, when the accounting mode is the time-rate accounting mode, the connection fee per a unit of time in the “unit time charged fee” field is charged. When the accounting mode is the content-by-content accounting mode, the connection fee per content in the “registered URL fee” field corresponding to the URL is charged. The fees thus charged to the individual communication subscribers are collected per month, and the selection system manager requests the carrier to gather the fees. As shown in FIG. 17, the carrier receiving this request collects from each individual communication subscriber the collection-requested fee plus a fee for using the public network 2. Then, this carrier reduces the fee for using the public network 2 and a fixed margin from the fee collected from each communication subscriber, and pays a remainder to the selection system manager. Then, the selection system manager recalculates the amount of money received from the carrier for every ISP, divides the recalculated amount of money with reducing a fixed rate of margin, and pays the divided amount of money to each ISP. Each of the ISPs reduces a fixed rate of margin from the amount of money received from the selection system manager and returns it to each content provider (CP).

As discussed above, according to this embodiment, the service provider fee information table (FIG. 4) is stored with the connection fee (registered URL fee) per Web content that is set independently by each ISP, and further the first accounting mode selecting information table (FIG. 5) is registered with the ISP identifying information (selected service provider ID) of the ISP setting the minimum connection fee (registered URL fee) for each the content URL (registered URL) in the service provider fee information table (FIG. 4). Accordingly, when the each individual communication subscriber tries to access any one of the contents from his or her subscriber terminal 1, the ISP of which identifying information is registered with respect to the URL of the content registered in the first accounting mode information table is selected and the subscriber terminal is linked to the content as the access destination via the Internet connecting device 4 administered by this selected ISP.

According to this embodiment, the mode (content-by-content accounting mode) for charging a fee each time a content is accessed and the mode (time-rate accounting mode) for charging a fee per a unit of access time may be registered as accounting modes in accounting mode selection field of the subscriber information table (FIG. 2). Corresponding to this scheme, the “unit time charged fee” filed of the service provider fee information table (FIG. 4) is stored with the connection fee per a unit of time by each ISP themselves. Further the ISP identifying information of the ISP setting the minimum connection fee per a unit of time registered in the “unit time charged fee” field of the service provider fee information table (FIG. 4) is registered in the “selected service provider ID” field of the second accounting mode selecting information table (FIG. 6). Therefore, when each communication subscriber tries to access any one of the contents from his or her subscriber terminal 1, if the content-by-content accounting mode is registered with respect to this communication subscriber in the subscriber information table (FIG. 2), as explained above, there is selected the ISP of which identifying information is registered with respect to the URL of the content registered in the first accounting mode information table (FIG. 5). Whereas, if the time-rate accounting mode is registered with respect to this communication subscriber, the ISP of which identifying information is registered in the second accounting mode information table (FIG. 6) is selected.

According to this embodiment, the mode of selection prioritizing fee (1: accounting) or the mode of selection prioritizing communication speed (2: communication speed) can be previously chosen as the ISP selection mode and registered in the “communication selection” field in the subscriber information table (FIG. 2). Corresponding to this scheme, the response time (that is, communication speed) in the case of accessing the specified content via the Internet connecting device 4 administered by each ISP is registered for the ISP identifying information (service provider ID) of the ISP in the service provider information table (FIG. 3). Further the ISP identifying information of the ISP offering the shortest response time among those registered in the “communication speed” field of the service provider information table (FIG. 3) is registered in the “service provider ID” field of the communication speed selecting information table (FIG. 7). Hence, when each communication subscriber tries to access any one of the content from his or her subscriber terminal 1, if the mode of selection prioritizing fee is registered in the subscriber information table (FIG. 2) with respect to this communication subscriber, as discussed above, the ISP is selected based on the first accounting mode information table (FIG. 5) or the second accounting mode information table (FIG. 6). In the case where the mode of selection prioritizing communication speed is registered with respect to the communication subscriber the ISP (service provider ID) registered in the communication speed selecting information table (FIG. 7) is selected.

As described above, according to this embodiment, each time the communication subscriber accesses the specified content, there are automatically selected the ISP providing the Internet connection service at the lowest connection fee at that accessing time or the ISP providing the Internet connection service at the highest speed in accordance with the subscriber's intent. Then, the subscriber terminal 1 is connected to the Internet 5 via the Internet connecting device 4 administered by the selected ISP and further becomes accessible to the Web site 6 on which this content is provided.

According to the Internet connecting device automatic selection method of the present invention having the architecture described above, each time the user operating the information terminal linked to the public network accesses the content on the Internet, there is selected the ISP offering the lowest fee for providing the Internet connection service for accessing the access target content among the ISPs registered beforehand.

We claim:

1. An Internet connecting device automatic selection method of selecting any one of a plurality of Internet connecting devices for connecting a public network to the Internet in order for one of communication terminals linked to the public network to access a content on the Internet via said selected Internet connecting device, said method comprising steps of:
referring to a table stored with information about said Internet connecting device offering a minimum connecting fee for each content when any one of said communication terminals requests to access a specified content on the Internet, to select said Internet connecting device registered with respect to the specified content in said table; and
making said communication terminal access the specified content via said selected Internet connecting device.

2. An Internet connecting device automatic selection method according to claim 1, wherein said table is structured of:
a first table stored with a connecting fee for each content that is independently offered by a party administering said each Internet connecting device with identifying information of the content and identifying information of the party; and
a second table stored, for every content, with the identifying information of the party offering the minimum connecting fee among those registered in said first table together with the identifying information of this content.

3. An Internet connecting device automatic selection method according to claim 2, wherein said first table is stored further with a connecting fee per a unit of time independently offered by the party administering said each Internet connecting device, and said method comprising steps of;
registering a third table with the identifying information of the party offering the minimum connecting fee per a unit of time among those registered in said first table,
registering a fourth table with information indicating which accounting mode an owner of said each communication terminal desires for, a mode of charging a fee each time a content is accessed, or a mode of charging a fee per a unit of accessing time,
when any one of said communication terminals requests to access a specified content on the Internet, selecting said Internet connecting device administered by the party registered with respect to said specified content in said second table, if said fourth table is registered with that the owner of said communication terminal desires for the mode of charging a fee each time a content is accessed, whereas, selecting said Internet connecting device administered by the party registered in said third table if said fourth table is registered with that the owner of said communication terminal desires for the mode of charging a fee per a unit of time, and
making said communication terminal access the specified content via said selected Internet connecting device.

4. An Internet connecting device automatic selection method according to claim 3, further comprising steps of;
registering said fourth table further with information indicating which selection the owner of said each communication device desires for, a selection prioritizing fee or a selection prioritizing communication speed,
registering a fifth table with communication speed of said each Internet connecting device together with the identifying information of the party administering said Internet connecting device,
registering a sixth table with the identifying information of the party administering said Internet connecting device exhibiting the highest communication speed among those registered in said fifth table,
when any one of said communication terminals requests to access a specified content on the Internet, selecting said Internet connecting device administered by the party registered in said second table or said third table if said fourth table is registered with that the owner of said communication terminal desires for the selection prioritizing fee, whereas, selecting said Internet connecting device administered by the party registered in said sixth table if said fourth table is registered with that the owner of said communication terminal desires for the selection prioritizing communication speed, and
making said communication terminal access the specified content via said selected Internet connecting device.

5. An Internet connecting device automatic selection system to be linked to communication terminals via a public network and also to be linked to a plurality of Internet connecting devices for connecting the public network to the Internet, said system comprising:
a first storage module registering a connection fee for each content that is independently offered by a party administering said each Internet connecting device with identifying information of the content and identifying information of the party;
a second storage module registering, for every content, the identifying information of the party offering the minimum connection fee among those registered in said first storage module together with the identifying information of the content;
a selection module selecting, when any one of said communication terminals requests to access a specified content on the Internet, said Internet connecting device administered by the party registered with respect to the specified content in said second storage module; and
a connection module having the specified content accessed by said communication terminal by connecting said communication terminal to said selected Internet connecting device.

6. An Internet connecting device automatic selection program to be read by a computer including interfaces to be linked to communication terminals via a public network and also to be linked to a plurality of Internet connecting devices for connecting the public network to the Internet, and a storage device, to make the computer execute steps of:
registering, on a first table stored in said storage device, a connecting fee for each content that is independently offered by a party administering said each Internet connecting device with identifying information of the content and identifying information of the party;
registering, for every content, the identifying information of the party offering the minimum connecting fee among those fees registered in said first table in a second table on said storage device together with the identifying information of the content;
selecting, when any one of said communication terminals requests to access a specified content on the Internet, said Internet connecting device administered by the party registered with respect to the specified content in said second table; and
having the specified content accessed by said communication terminal via said selected Internet connecting device.
